(19) United States
(12) Patent Application Publication
(10) Pub. No.: US 2010/0026498 A1
(43) Pub. Date: Feb. 4, 2010

(54) Method and System for Adapting a Mobile Computing Device with an RFID Antenna

(76) Inventors: David Bellows, Wantagh, NY (US); Thomas Wulff, North Patchogue, NY (US)

Correspondence Address: MOTOROLA, INC., 1303 EAST ALGONQUIN ROAD, IL01/3RD, SCHAUMBURG, IL, 60196, US

(21) Appl. No.: 12/181,549

(22) Filed: Jul. 29, 2008

(51) Int. Cl. G08B 13/14

(52) U.S. Cl. 340/572.7

(57) ABSTRACT

The present invention relates to systems, methods, and devices, for adapting a radio frequency identification (“RFID”) antenna, such as an ultrahigh frequency (“UHF”) antenna, at a front end of a mobile computing device without impacting the performance of the device. Described is a device including a housing having a front end, a data capturing arrangement positioned on the front end, the data capturing arrangement collecting data from one or more automatic identification items, and at least one antenna positioned at the front end, the at least one antenna transmitting and receiving data from at least one target over a radio frequency. Further described is a system including a mobile computing device including a housing having a front end, a data capturing arrangement positioned on the front end, the data capturing arrangement collecting data from one or more automatic identification items, and at least one antenna positioned at the front end, the at least one antenna transmitting and receiving data from at least one target over a radio frequency.

### FIELD OF INVENTION

The present invention generally relates to systems and methods for adapting a radio frequency identification (“RFID”) antenna, such as an ultrahigh frequency (“UHF”) antenna, at a front end of a mobile computing device without impacting the performance of the device.

### BACKGROUND

Mobile computing devices, or mobile units (“MUs”), such as RFID readers, are used in a multitude of situations for both personal and business purposes. As the benefits of utilizing MUs expand rapidly across more industries, the features of these products expand at a corresponding pace. Accordingly, a demand exists for MUs to perform more complicated tasks in a quick, efficient and reliable manner.

Radio frequency identification (“RFID”) technology includes systems and methods for non-contact reading of targets (e.g., products, people, vehicles, livestock, etc.) in order to facilitate effective management of these targets within a business enterprise. Specifically, RFID technology allows for the automatic identification of targets, storing target location data, and remotely retrieving target data through the use of RFID tags, or transponders. The RFID tags are an improvement over standard bar codes since the tags may have read and write capabilities. Accordingly, the target data stored on RFID tags can be changed, updated and/or locked. Due to the ability to track moving objects, RFID technology has established itself in a wide range of markets including retail inventory tracking, manufacturing production chain, and automated vehicle identification systems. For example, through the use of RFID tags, a retail store can see how quickly the products leave the shelves, and gather information on the customer buying the product.

Within an RFID system, the antenna used for an RFID tag is affected by the intended application and the frequency of operation. The frequencies utilized by the antenna may include low frequencies (e.g., in the range of 30 kHz-300 kHz), high frequencies (e.g., in the range of 3 MHz-30 MHz), ultra-high frequencies (e.g., in the range of 300 MHz-3 GHz), etc. Furthermore, the RFID tag may be a device that is either applied directly to, or incorporated into, one or more targets for the purpose of identification via radio signals. A typical RFID tag may contain at least two parts. A first part is an integrated circuit for storing and processing information, as well as for modulating and demodulating a radio signal. A second part is an antenna for receiving and transmitting radio signals including target data. A typical RFID reader may contain a radio transceiver and may be capable of receiving and processing these radio signals from several meters away and beyond the line of sight of the tag.

### SUMMARY OF THE INVENTION

The present invention relates to a device for adapting a radio frequency identification (“RFID”) antenna, such as an ultrahigh frequency (“UHF”) antenna, at a front end of a mobile computing device without impacting the performance of the device. The device includes a housing having a front end, a data capturing arrangement positioned on the front end, the data capturing arrangement collecting data from one or more automatic identification items, and at least one antenna positioned at the front end, the at least one antenna transmitting and receiving data from at least one target over a radio frequency.

The present invention relates to a system for adapting a radio frequency identification (“RFID”) antenna, such as an ultrahigh frequency (“UHF”) antenna, at a front end of a mobile computing device without impacting the performance of the device. The system including a mobile computing device including a housing having a front end, a data capturing arrangement positioned on the front end, the data capturing arrangement collecting data from one or more automatic identification items, and at least one antenna positioned at the front end, the at least one antenna transmitting and receiving data from at least one target over a radio frequency.

### BRIEF DESCRIPTION OF THE DRAWINGS

FIG. 1 shows an exemplary embodiment of a system for adapting a radio frequency identification (“RFID”) antenna, such as an ultrahigh frequency (“UHF”) antenna, at a front end of a mobile computing device according to the exemplary embodiments of the present invention.

FIG. 2a shows a block diagram of a system including a permanent antenna component, such as a UHF RFID antenna, on a general-purpose handheld mobile computing device, such as the MU, according to the exemplary embodiments of the present invention.

FIG. 2b shows a block diagram of a system for adapting a detachable antenna, such as a UHF RFID antenna, onto a general-purpose handheld mobile computing device, such as the MU, according to the exemplary embodiments of the present invention.

### DETAILED DESCRIPTION

The exemplary embodiments of the present invention may be further understood with reference to the following description of exemplary embodiments and the related appended drawings, wherein like elements are provided with the same reference numerals. The exemplary embodiments of the present invention are related to systems and methods for optimizing the use of a radio frequency identification (“RFID”) antenna on a handheld device. Specifically, the present invention is related to a system and method for adapting an ultrahigh frequency (“UHF”) antenna at a front end of a general-purpose handheld mobile computing device, or mobile unit (“MU”).

An exemplary embodiment of the MU may include, but is not limited to, a laser based scanner, an image-based scanner, a radio frequency identification (“RFID”) reader, a personal digital assistant (“PDA”), a mobile telephone, a portable gaming console, a laptop, etc. Various embodiments of the present invention will be described with reference to an exemplary MU. However, those skilled in the art will understand that the present invention may be implemented with any electrical and/or mechanical hand-operated device that can be attached to a modular accessory.

Conventional MUs, such as scanning devices, do not have an expansion port to accommodate accessories on the scanning end of the device. Specifically, there has not been an opportunity to improve on the feature set of scanning devices in a modular manner due to the fact that the design form and ergonomics of the scanning devices have not lent themselves to this level of integration. Accordingly, scanner accessories are typically limited only to power cables or support stands. Furthermore, existing accessories have been limited to cable interfaces located at the base (e.g., the foot) of the scanning device. Thus, a user's ability to add features (e.g., modules, accessories, etc.) to their MUs, without impacting the performance of the MU, is limited.

Furthermore, an antenna's performance is directly linked to the size and the location of the antenna, relative to potential targets (e.g., RFID tags) of the MU. This is especially true for UHF RFID antennas, which may be relatively large compared to the size of the MU. Accordingly, the exemplary systems and method of the present invention address this issue. As will be described in greater detail below, the exemplary systems and methods position the antenna in an optimized location without severely compromising the overall performance of the MU and without limiting any other features of the MU.

An effective approach to optimizing the size and location of an antenna (e.g., a UHF RFID antenna), according to the exemplary embodiments of the present invention, may be to place the antenna at the front end of the MU (e.g., around an exit window of a barcode scanner). As will be described in greater detail below, an expansion port of the MU may be disposed at a face portion, or a front side, of the MU. For instance, in the example in which the MU is a scanning device, the expansion port may be deposed at a scan exit window on the front side of the device. Accordingly, exemplary electrical and mechanical interfaces may be included within the expansion port of the MU, thereby allowing for modules such as a UHF RFID antenna to be integrated (e.g., plugged, connected, coupled, etc.) into the front side of the MU and add additional functions to the overall performance of the MU.

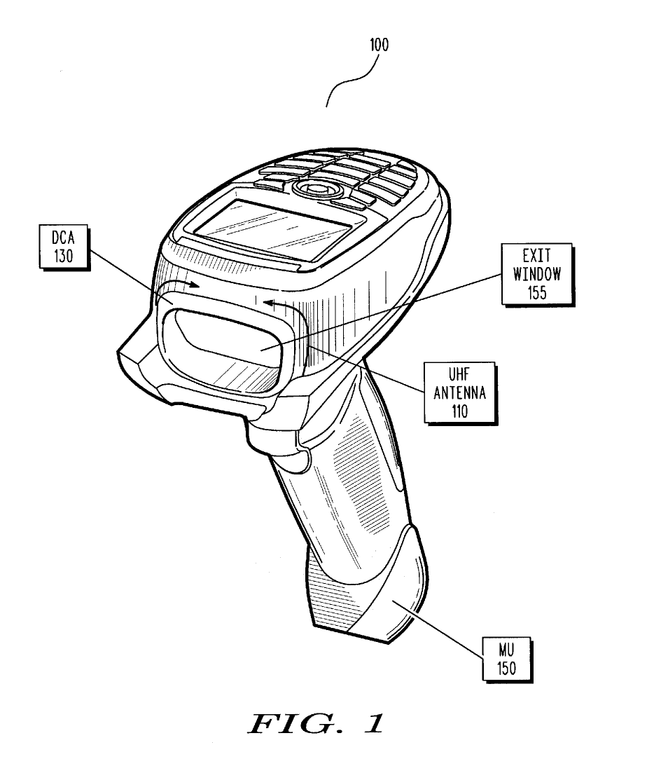

FIG. 1 shows an exemplary embodiment 100 of a system for adapting a radio frequency identification (“RFID”) antenna, such as an ultrahigh frequency (“UHF”) antenna 110, at a front end of a mobile computing device, such as MU 150, according to the exemplary embodiments of the present invention. As described above, the MU 150 may be a general-purpose handheld computing device, such as a barcode scanner that also includes RFID reader functionality. Accordingly the MU 150 may include an exit window 155 for transmission (e.g., collection) of data between the MU 150 and an external object, such as a bar code, an image, etc.

According to the exemplary embodiments of the MU 150, the UHF RFID antenna 110 may be positioned either in front of, or alternatively, behind the exit window 155. It should be noted that the exemplary the antenna 110 may be described as being part of an expansion module that connects with the MU 150, the antenna may alternatively be a permanent component in the MU 150. Regardless of the placement and the detachability of the antenna 110, the size of the antenna 110 may take advantage of the available frontal area of the MU 150. Thus, locating the antenna 110 at the front end of the MU 150 positions the antenna 110 for optimal performance (e.g., RF performance).

It should be noted that while the exemplary embodiments of the present invention may be described as utilizing the UHF RFID antenna 110, the principles and applications of the exemplary embodiments may be implemented with any type of antenna, such as, for example a high-frequency (“HF”) antenna, a hybrid HF/UHF antenna, etc. While HF RFID readers may not have as fast a read rate as UHF readers, the HF antenna may offer greater capacity to read in hostile environments, such as with liquids and metals. Furthermore, HF antennas may also be more effective at reading multiple items in a small space, such as many bottles stacked in a carton passing through assembly lines. While UHF readers may be capable of transmitting in the near-field similar to HF, the UHF antennas are faster and work well over longer distances (far-field). Thus, the UHF RFID antenna 110 may be designed to operate in both the far-field (e.g., the case/pallet-level) and the near-field (e.g., the item-level). Those skilled in the art would understand that an HF antenna may operate within a range of 3 MHz-30 MHz, while a UHF antenna may operate within a range of 300 MHz-3 GHz.

Therefore, according to one exemplary embodiment of the present invention, the exemplary MU 150 may be used at a storage facility, such as a warehouse facility. For example, the MU 150 may be capable of scanning a barcode of a pallet of goods for storage. Accordingly, a user may wish to also track the pallet via an UHF RFID tag on the pallet. Therefore, the exemplary UHF RFID antenna 110 may provide an RFID communication function to the MU 150. In another example, the MU 150 may gather item-specific inventory information within the warehouse setting. For example, the MU 150 may retrieve and display a list of items inventoried by the user. Accordingly, the user may utilize the UHF RFID antenna 110 to track the locations of UHF RFID tags placed on items, on other MUs, on another user, etc. Alternatively or additionally, the user may wish to transmit the collected information to an access point within wireless local area network (“WLAN”). Therefore, the exemplary MU 150 may be provided a WLAN communication function.

As described above, the exemplary embodiments of the systems and method may allow for the UHF RFID antenna 110 to be detachably connected to the MU 150. Accordingly, the MU 150 may include the expansion port (not shown) at the front end of the MU 150 (e.g., near the scan exit window) without impacting the performance of the device. It should be noted that the front end of the MU may include an arrangement for receiving and/or transmitting data. For example, the MU 150 may include a data capturing arrangement (“DCA”) 130 for collecting data from items such automatic identification items (e.g., barcode, image data, RFID tags, etc.). Accordingly, the front end of the MU 150 may be described as, but is not limited to, a data receiving end, a barcode scanning end (e.g., the scan exit window), etc. The DCA 130 may include one or more modules for electronically capturing data (e.g., receiving and/or transmitting data). For example, these modules may include, but are not limited to automatic identification devices. Thus, an exemplary DCA 130 may utilize one or more RF antennas, barcode lasers, imaging devices, etc.

While the exemplary UHF antenna 110 may attached to the expansion port on the MU 150, the systems and methods of the present invention may include alternative or additional antennas and/or modules to be attached to the expansion port. For example, additional modules may include a HF RFID antenna, electronic article surveillance (“EAS”) readers, local area network (“LAN”) modules, wide area network (“WAN”) modules, personal area network (“PAN”) modules, modems, magnetic stripe readers, smart card readers, voice recognition devices, biometric readers, etc. Thus, any feature that may be appropriate for modularization may be implemented within the expansion port at the front end of the MU 150.

According to the exemplary embodiments of the MU 150, locating the expansion port in the front end may enable many possible modular accessories to be designed, implemented, and used by a user of the MU 150. For example, a modular RFID accessory may be added to the MU 150 by the user, thereby easily adding RFID reader functionality to the MU 150. Furthermore, the user may also remove the UHF RFID antenna 110 when this functionality is not needed. In other words, the user may easily switch an operation of the MU 150 from a first application (e.g., UHF RFID scanning) to a second application (e.g., HF RFID scanning). Thus, the exemplary systems and methods may add considerable value to existing products by eliminating the need for a second device.

In the embodiment in which the UHF RFID antenna 110 is detachable from the MU 150, the expansion port may be mated to a receiving arrangement of the UHF RFID antenna 110 in order to securely maintain both a mechanical and an electrical connection between the two components. Although the exemplary embodiments described herein utilize an externally coupled accessory device, other embodiments may include accessory devices that are internally coupled to the MU 150. For example, in one embodiment, the MU 150 may include a compartment for receiving the UHF RFID antenna 110, which may be placed therewithin by sliding, snapping, rotating, etc. Thus, the UHF RFID antenna 110 may be partially or fully received within the housing of the MU 150. Furthermore, in the alternative, the UHF RFID antenna 110 may be a permanent component of the MU 150.

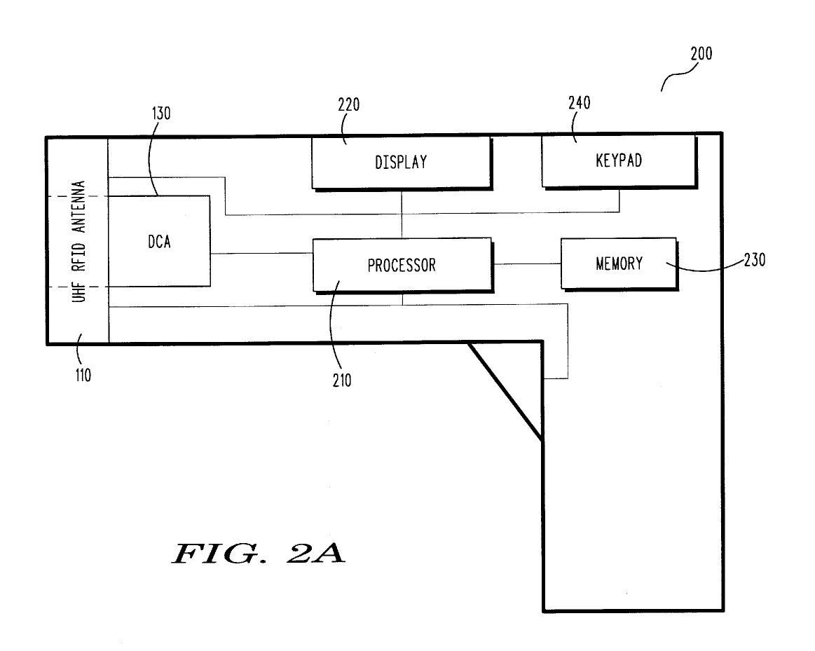

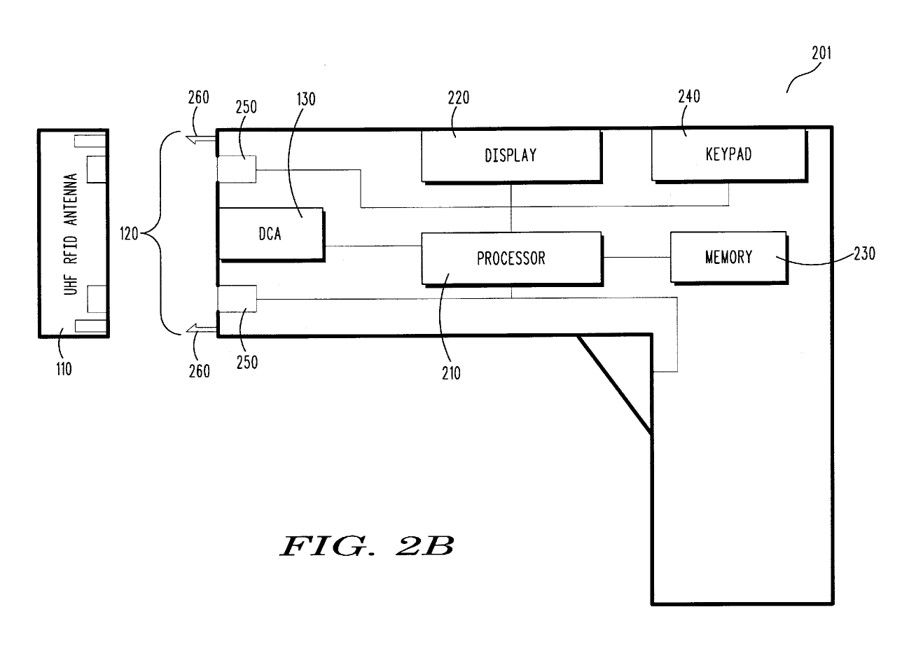

FIG. 2a shows a block diagram 200 of a system including a permanent antenna component, such as a UHF RFID antenna 110, on a general-purpose handheld mobile computing device, such as the MU 150, according to the exemplary embodiments of the present invention. As shown in FIG. 2a, the exemplary MU 150 may include a processor 210, a display screen 220, a memory 230, the DCA 130 (e.g., a barcode scanner, a RFID reader, magnetic stripe reader, smart card reader, etc.), a keypad 240, and an antenna, such as the UHF RFID antenna 110. Furthermore, the MU 150 may incorporate any number of automatic identification data capturing methods.

The processor 210 may include one or more electrical components for executing a function of the exemplary MU 150. For example, if the DCA 130 of the MU 150 includes a barcode scanner/reader, then processor 210 may include an arrangement for reading data electronically captured from reading a barcode. Furthermore, if the DCA 130 of the MU 150 further includes an RFID reader, then processor 210 may also, or alternatively, include an arrangement for receiving data from RF tags. The processor 210 may also include software components for controlling operation of the various electrical/hardware components of the MU 150.

In addition, the processor 210 may regulate the operation of the MU 150 by facilitating communications between the various components of the MU 150, as well as communication between the MU 150 and an attached mobile computing device. For example, the processor 210 may include one or more microprocessors, an embedded controller, an application-specific integrated circuit, a programmable logic array, etc. The processor 210 may perform data processing, execute instructions and direct a flow of data between devices coupled to the MU 150 (e.g., the display screen 220, the DCA 130, the keypad 240, etc.). The processor 210 may communicate this data to a remote device via the wireless communication interface (e.g., using a Bluetooth protocol, an IEEE 802.1x protocol, a WAN Protocol, etc.).

Furthermore, the processor 210 may be in communication with the UHF RFID antenna 110. As described above, the UHF RFID antenna 110 may allow for non-contact reading of targets, such as RFID tags, in order to facilitate effective management of these targets within a business enterprise. Specifically, the UHF RFID antenna 110 may allow for the automatic identification of targets through remotely retrieving target data through the use of the RFID tags. The target data may allow the processor 210 to generate location data for each of the RFID tags. This location data may be displayed to a user of the MU 150 via the display screen 220.

The display screen 220, as described above, may display viewable data images generated by the processor 210. According to one example, the display screen 220 may include a touch screen. Specifically, a display screen 220 implemented as a touch screen serves as an input device that may supplement the keypad 240 and/or a pointing device (e.g., a mouse). Therefore, the touch screen may allow the user to interact with a graphical user interface (“GUI”) on the display screen 220 via a stylus or the user's finger.

The memory 230 may be any storage medium capable of being read from and/or written to by the processor 210. The memory 230 may include any combination of volatile and/or nonvolatile memory (e.g., RAM, ROM, EPROM, Flash, etc.). In addition, the memory 230 may also include one or more storage disks such as a hard drive. Accordingly, the memory 230 may be a temporary memory in which data (e.g., captured data, verification data, etc.) may be temporarily stored until it is transferred to a different storage location (e.g., an expansion port). In another embodiment, the memory 230 may be a permanent memory comprising an updateable database.

FIG. 2b shows a block diagram 201 of a system for adapting a detachable antenna, such as a UHF RFID antenna 110, onto a general-purpose handheld mobile computing device, such as the MU 150, according to the exemplary embodiments of the present invention. Similar to the illustration shown in FIG. 2a, the exemplary MU 150 in FIG. 2b may include a processor 210, a display screen 220, a memory 230, the DCA 130 (e.g., a barcode scanner, a RFID reader, magnetic stripe reader, smart card reader, etc.), a keypad 240, and the UHF RFID antenna 110. In addition, the MU 150 may further include an electrical interface 250, and a mechanical interface 260.

According to the exemplary embodiments of the present invention, the mechanical interface 260 allows the UHF RFID antenna 110 to be physically attached to the front end of the MU 150. Specifically, the mechanical interface 260 may allow for the UHF RFID antenna 110 to detachably couple to an expansion port 120 of the MU 150. For example, the mechanical interface 260 may comprise one or more slots selectively coupled to one or more corresponding interlocking tabs located on a housing of the MU 150. The mechanical interface 260 may also be located on the front end of the MU 150, and slots may be shaped to complement the tabs, allowing the MU 150 to be snapped into place. Those of skill in the art will understand that the MU 150 may utilize any mechanism for detachably receiving the UHF RFID antenna 110 at the expansion port 120 including, but not limited to, screws, hooks, clasps, adhesives, Velcro®, magnets, etc.

Once the UHF RFID antenna 110 is attached to the MU 150, the electrical interface 250 may create an electrical connection in which data may be exchanged between the components. Specifically, the electrical interface 250 may include one or more electrical contacts for attaching the UHF RFID antenna 110 to an MU 150. For example, the contacts may comprise one or more sets of input/output (I/O) pins, such as a Universal Serial Bus (USB) port, a serial port, etc. In addition, the electrical interface 250 may provide power and/or data transfer capabilities to a conventional (e.g., legacy) accessory device. However, it should be noted that the UHF RFID antenna 110 may be a self-powered device and/or may receive power wirelessly (e.g., via induction) from the MU 150 or a further source.

As described above in FIG. 2a, the UHF RFID antenna 110 may be a permanent component integrated within the MU 150. However, alternative embodiments of the exemplary MU 150 having an integrated antenna may also include the expansion port 120. Therefore, the implementation of the expansion port 120 allows for future growth on the MU 150. Specifically, the system 100 may add feature modularity, in addition to the use of the UHF RFID antenna, with the expansion port 120 on the front end of the MU 150. Therefore, a user may decide, after a product (e.g., the MU 150) has been purchased, that additional functionality may be required. With the expansion port 120 built into the front end of the product, the user may simply purchase an add-on expansion module, thereby adding application flexibility to the product, as well as extending the lifespan of the product.

Therefore as either a permanent component of the MU 150 (as illustrated in FIG. 2a) or as a part of an optional expansion module that connects to the MU 150 (as illustrated in FIG. 2b), the exemplary embodiments of the present invention may be designed to take advantage of the available frontal area of the MU 150. Specifically, the exemplary embodiments may optimize the size and the location of the UHF antenna 110 by placing the antenna 110 at the front end of the MU 150. For example, the antenna 110 may be placed around the exit window 155 of the MU 150 for optimal RF performance, without compromising the overall performance or the features of the MU 150. That is, the area utilized on the front end of the MU 150 for the antenna placement has sufficient space to accommodate an antenna of a relatively large size, such as the UHF RFID antenna 110. In addition, by placing the antenna 110 in the front end of the MU 150, a user should naturally point the antenna 110 in the optimal direction (e.g., towards an RFID target) for the collection of RFID data.

It will be apparent to those skilled in the art that various modifications may be made in the present invention, without departing from the spirit or the scope of the invention. Thus, it is intended that the present invention cover modifications and variations of this invention provided they come within the scope of the appended claimed and their equivalents.

What is claimed is:

1. A device, comprising:
a housing having a front end;
a data capturing arrangement positioned on the front end, the data capturing arrangement collecting data from one or more automatic identification items; and
at least one antenna positioned at the front end, the at least one antenna transmitting and receiving data from at least one target over a radio frequency.

2. The device according to claim 1, further comprising:
an expansion port positioned on the front end, wherein the at least one antenna is detachably connected to the expansion port; and
a connection interface positioned on the expansion port, the connection interface including at least one of an electrical interface and a mechanical interface.

3. The device according to claim 2, further comprising:
a processor regulating an operation of the device by facilitating communications between the expansion port and the at least one antenna, the processor processing the data collected from the data capturing arrangement.

4. The device according to claim 1, wherein the data capturing arrangement includes a scan exit window and the at least one antenna is positioned at least partially around the scan exit window.

5. The device according to claim 1, wherein the data capturing arrangement includes one of a barcode reader, an imaging sensor, a radio frequency identification (“RFID”) antenna, a location awareness system, and a global positioning system.

6. The device according to claim 1, wherein the at least one antenna is one of an ultrahigh radio frequency identification (“RFID”) antenna and a high frequency antenna for wirelessly communicating with the at least one or more targets, the targets including at least one of an RFID tag, a GPS tag, a router, an access point, and a further device.

7. A system, comprising:
a mobile computing device including a housing having a front end, a data capturing arrangement positioned on the front end, the data capturing arrangement collecting data from one or more automatic identification items; and
at least one antenna positioned at the front end, the at least one antenna transmitting and receiving data from at least one target over a radio frequency.

8. The system according to claim 7, wherein the mobile computing device further includes an expansion port positioned on the front end, wherein the at least one antenna is detachably connected to the expansion port, and a connection interface positioned on the expansion port, the connection interface including at least one of an electrical interface and a mechanical interface.

9. The system according to claim 8, wherein the mobile computing device further includes a processor regulating an operation of the device by facilitating communications between the expansion port and the at least one antenna, the processor processing the data collected from the data capturing arrangement.

10. The system according to claim 7, wherein the data capturing arrangement includes a scan exit window and the at least one antenna is positioned at least partially around the scan exit window.

11. The system according to claim 7, wherein the data capturing arrangement includes one of a barcode reader, an imaging sensor, a radio frequency identification (“RFID”) antenna, a location awareness system, and a global positioning system.

12. The system according to claim 7, wherein the at least one antenna is one of an ultrahigh radio frequency identification (“RFID”) antenna and a high frequency antenna for wirelessly communicating with the at least one or more targets, the targets including at least one of an RFID tag, a GPS tag, a router, an access point, and a further device.

13. A device, comprising:
a housing having a front end;
a data capturing means, positioned on the front end, for collecting data from one or more automatic identification items; and
at least one radio transmission means, positioned at the front end, for transmitting and receiving data from at least one target over a radio frequency.

14. The device according to claim 13, further comprising:
an expansion port means, positioned on the front end, for receiving an expansion module increasing the functionality of the device; and
a connection interface means, positioned on the front end of the housing, for one of electrically and mechanically coupling the expansion module to the expansion port means.

15. The device according to claim 14, further comprising:
a processing means for regulating an operation of the device by facilitating communications between the expansion port means and the at least one radio transmission means, the processing means processing the data collected from the data capturing arrangement.

16. The device according to claim 13, wherein the data capturing means includes a scan exit window and the at least one antenna is positioned at least partially around the scan exit window.

17. The device according to claim 13, wherein the data capturing means includes one of a barcode reader, an imaging sensor, a radio frequency identification (“RFID”) antenna, a location awareness system, and a global positioning system

18. The device according to claim 13, wherein the at least one radio transmission means is one of an ultrahigh radio frequency identification (“RFID”) antenna and a high frequency antenna for wirelessly communicating with the at least one or more targets, the targets including at least one of an RFID tag, a GPS tag, a router, an access point, and a further device.
